(19) United States
(12) Patent Application Publication
(10) Pub. No.: US 2009/0300278 A1
(43) Pub. Date: Dec. 3, 2009

(54) Embedded Programmable Component for Memory Device Training

(75) Inventor: Warren F. Kruger, Sunnyvale, CA (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Advanced Micro Devices, Inc., Sunnyvale, CA (US)

(21) Appl. No.: 12/475,138

(22) Filed: May 29, 2009

Related U.S. Application Data
(60) Provisional application No. 61/071,989, filed on May 29, 2008.

(51) Int. Cl. G06F 15/18; G06F 12/02; G06F 15/76; G06F 1/32

(52) U.S. Cl. 711/105; 706/12; 711/E12.002; 712/41; 713/320; 712/E09.003

(57) ABSTRACT

A system and method by which a memory device can adapt or retrain itself in response to changes in its inputs or operating environment. The memory device, such as a DRAM, includes in its interface an embedded programmable component. The programmable component can be, for example and without limitation, a microprocessor, a microcontroller, or a microsequencer. A programmable component is programmed to make changes to the operation of the interface of the memory device, in response to changes in the environment of the memory device.

### CROSS REFERENCE TO RELATED APPLICATIONS

The present application claims the benefit of U.S. Provisional Patent Application No. 61/071,989, filed on May 29, 2008, entitled “Embedded Programmable Component for Memory Device Training” by Warren Kruger, which is incorporated herein by reference in its entirety.

### FIELD OF THE INVENTION

The present invention relates to memory devices and to training interfaces of such devices.

### BACKGROUND OF THE INVENTION

In the course of operation, a memory device such as a dynamic random access memory (DRAM) may encounter changes in its surrounding conditions. For example, the waveform of an incoming signal may change somewhat, making it more difficult to interpret the data. The data eye of such a signal may shift, making it harder to locate. Moreover, other conditions may change as well. The operational clock speed of the memory device may need to change, for example. Also, bandwidth at the interface to the memory device may have to change or be constrained, or power consumption may have to be adjusted. Such changes may affect the performance of the memory device.

Ideally, a memory device would have the ability to adapt to such changes to minimize their impact on its performance. However, currently the ability of memory devices to respond to such changing conditions is limited. Moreover, newer protocols such as the Graphics Double Data Rate 5 (GDDR5) require faster operation than other protocols, which would require a memory device to adapt to changing conditions quickly.

What is needed, therefore, is a system and method by which a memory device such as a DRAM can quickly adapt or retrain itself in response to changing conditions in its operating environment.

### BRIEF DESCRIPTION OF THE DRAWINGS/FIGURES

Embodiments of the invention are described with reference to the accompanying drawings. In the drawings, like reference numbers may indicate identical or functionally similar elements. The drawings in which an element first appears is generally indicated by the left-most digit in the corresponding reference number.

FIG. 1 is an exemplary system diagram of a memory device with a programmable component for interface training and testing, according to one embodiment of the invention.

FIG. 2 is a flow chart of an exemplary process for interface training of a memory device by the programmable component, according to one embodiment of the invention.

FIG. 3 is a flow chart of an exemplary process for adapting the memory interface when the programmable component is informed of a change in operating conditions, according to one embodiment of the invention.

### DETAILED DESCRIPTION OF THE INVENTION

In the detailed description of the invention herein, references to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

The invention described herein is a system and method by which a memory device can adapt or retrain itself in response to changes in its inputs or operating environment. The memory device, such as a DRAM, includes in its interface an embedded programmable component. The programmable component can be, for example and without limitation, a microprocessor, a microcontroller, or a microsequencer. The programmable component is programmed to make changes to the operation of the interface of the memory device, in response to changes in an input signal (e.g. changes in the waveform of the input signal) and/or the surrounding environment of the memory device.

In one embodiment, to respond to changes in the waveform of an input signal, for example, the programmable component can be programmed to detect changes in the waveform and retrain the interface of the memory device. The retraining allows the interface to detect the data eye of the changed input signal. This would allow the memory device to continue receiving and storing data contained in the input signal.

In some embodiments of the invention, the programmable component can be programmed to respond to other changes in the surrounding environment, such that the impact on the performance of the memory device due to such changes can be minimized. For example, in the course of operation, bandwidth requirements at the interface may become constrained or otherwise changed. In this case, the programmable component is programmed to change the operating parameters of the interface of the memory device according to the changed bandwidth requirements. In this way, the bandwidth parameters at the interface can be changed to meet the necessary bandwidth requirements. Similarly, the programmable component can be programmed to respond to other changes in the environment, such as changes to the clock rate, or constraints imposed on power consumption. In these cases, the programmable component effectively changes operating parameters at the interface of the memory device, and allows the memory device to continue its optimal operation under the new conditions. The operating parameters at the interface of the memory device may include timing parameters, address parameters, charging parameters, refreshing parameters, read/write parameters, etc. There examples are strictly illustrative and are not intended to limit the invention.

### System Overview

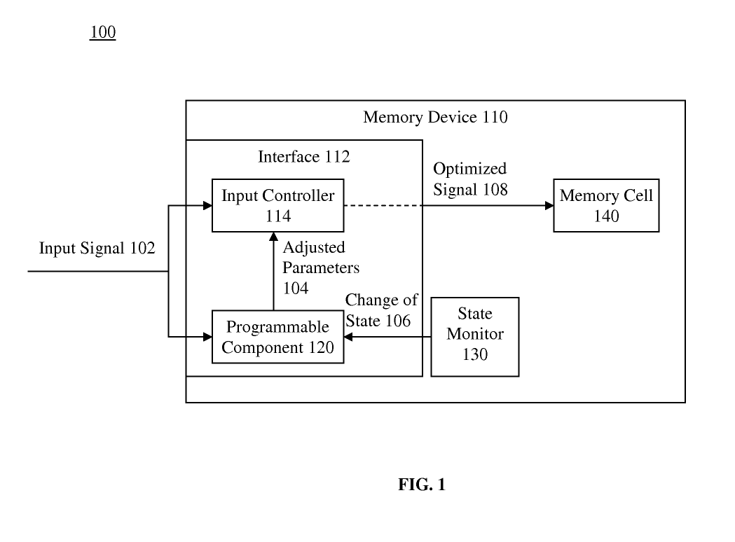

An embodiment of the invention is illustrated in FIG. 1. This figure shows a memory device 110. Memory device 110 can be, for example, a DRAM device. A signal 102 provides input data to memory device 110. Such data may include, for example, data to be stored in memory device 110. The input signal 102 enters memory device 110 through an interface 112. Interface 112 includes a programmable component 120. In the illustrated embodiment, programmable component 120 is in communication with an input controller 114, also located in interface 112. In this embodiment, input controller 114 controls the operation of interface 112. Input controller 114, however, is in turn affected by the output of programmable component 120, for example, but without limitation, operating parameters at the interface, sent to input controller 114.

As an example, the input signal 102 will typically be a digital waveform. Over time, and as a result of any of a number of processing and/or transmission factors, the waveform of input signal 102 may change somewhat. The changes to the waveform may make it difficult to locate the data eye of each bit of input signal 102. The term “data eye” refers to the point on a square wave that, when located and sampled, can be used to characterize an associated bit as either a logical 0 or 1. A signal representing n bits should have n data eyes. The input signal 102 would be received by programmable component 120 and such changes to the waveform would be detected by programmable component 120. Programmable component 120 would then direct input controller 114 to change its operation, so as to better detect the data eye of input signal 102. In the illustrated embodiment, this direction by programmable component 120 takes the form of adjusted parameters 104 that are communicated to input controller 114. This represents a retraining of interface 112 to deal with changes to input signal 102. As a result, input controller 114, when it receives input signal 102, reliably locates the data eye of the signal 102. The data would then be forwarded in the form of an optimized signal 108 to one or more memory cells 140.

The programmable component 120 can also be responsive to other changes in the operating environment of memory device 110. Bandwidth requirements at interface 112 may change, for example. Likewise, power requirements may change, or the operating clock rate of interface 112 may have to change. Such changes in the operating environment are detected by memory device 112 through one or more components which are identified generically as state monitor 130. Changes of the operating state of memory device 112 are communicated through a signal 106 to programmable component 120. In the illustrated embodiment, programmable component 120 would then adjust the operating parameters and communicate the adjusted operating parameters to input controller 114. Controller 114 would, in response, make the necessary operating changes according to the adjusted operating parameters. In this way, memory device 110 would be retrained, or self-tuned, in response to changes in the operating environment.

Note that programmable component 120 can be any one of several types. Programmable component 120, may, for example, be a microcontroller. Alternatively, programmable component 120 may be a microsequencer or a microprocessor. Further, in an embodiment of the invention, programmable component 120 may be programmed using instructions from a reduced instruction set. In addition, the embodiment of FIG. 1 illustrates input controller 114 and programmable component 120 as discrete components. In an alternative embodiment, programmable component 120 and input controller 114 may be implemented as a single programmable device.

### Interface Retraining

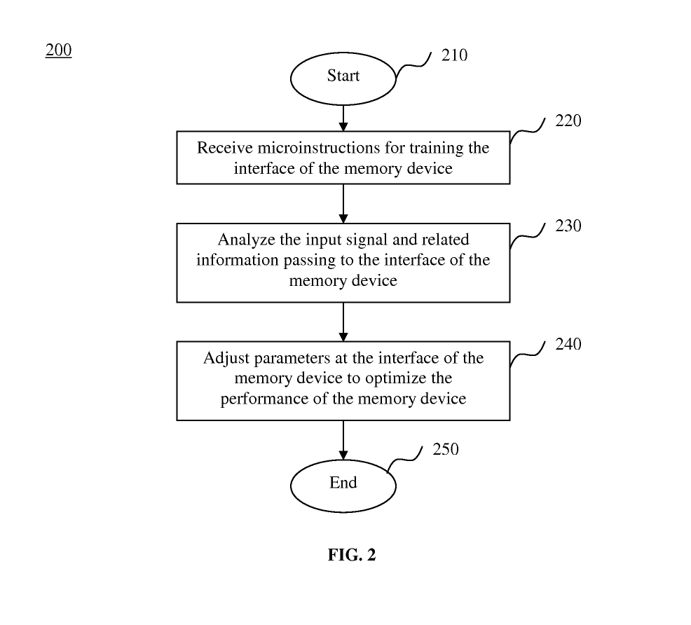

The processing of the invention corresponding to input signal changes according to an embodiment thereof is illustrated in FIG. 2. The process begins at step 210. In step 220, microinstructions are received at a programmable component in an interface of a memory device. The programmable component, the interface, and the memory device could be, for example, programmable component 120, interface 112, and memory device 110 of system 100. In an embodiment of the invention, the microinstructions are received from a memory controller. These microinstructions, when executed, perform the retraining of interface 112 of memory device 110. The retraining of interface 112 may include, for example but without limitations, adjusting operating parameters at interface 112 to optimize the performance of memory device 110 due to changes in the operating environment. In step 230, an input signal is analyzed by programmable component 120 to determine, for example, whether the waveform has changed such that the location of the data eye must be re-identified. The input signal could be, for example, input signal 102 shown in FIG. 1. In step 240, operating parameters at interface 112 are adjusted based on the changes in input signal 102. The adjusted parameters would allow memory device 110 to identify the data eye of the changed input signal and optimize the signal accordingly. In this way, the performance of memory device 110 can be optimized when receiving and storing the changed input signal. The process concludes at step 250. In an alternative embodiment, programmable component 120 may communicate the adjusted parameters to input controller 114 for optimizing the changed signal.

Note that once the memory device is retrained in this manner, the interface of the memory device can better locate the data eye of the input signal. As is well known in the art, there are a number of well understood algorithms by which a data eye can be located. For example, the left edge of a square edge could be located, and the search for the data eye would then be focused to the right of this edge. Alternatively, the data eye could be located by oversampling and filtering.

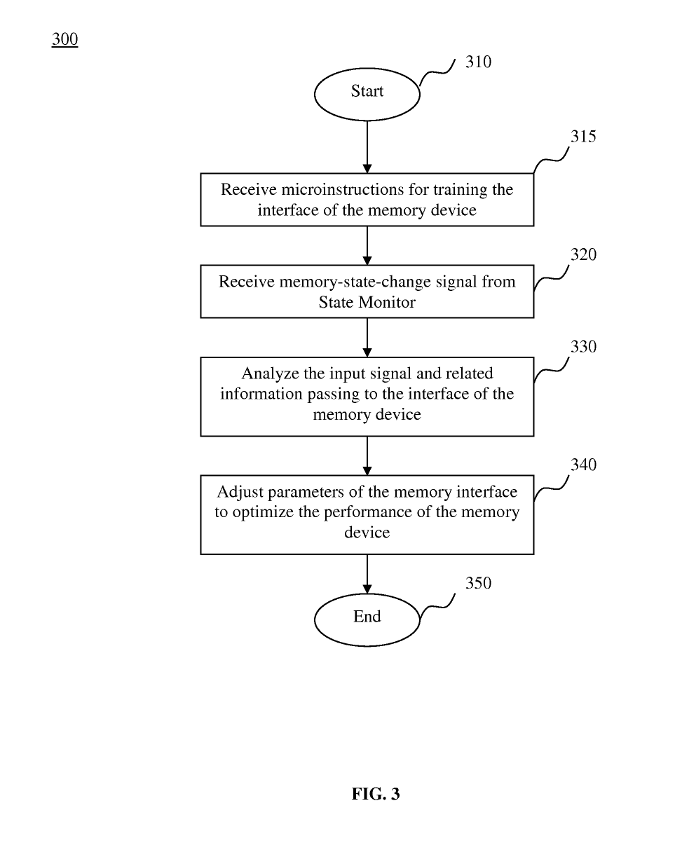

FIG. 3 illustrates the processing of an embodiment of the invention, where the interface of the memory device self-tunes in response to changes in the operating environment of the memory device, while responding to changes in the waveform of the input signal. The process begins at step 310. In step 315, microinstructions are received at the programmable component, such as programmable component 120. In step 320, the programmable component receives a signal from a state monitor, such as state monitor 130 of system 100, signifying that there has been a state change, such as a need for reduced power consumption, or a different bandwidth or clock requirement. The signal could be the signal of change of state 106 shown in FIG. 1. In step 330, the input signal is received at programmable component 120, and analysis is performed on the input signal based on change of state 106 in order to determine whether interface 112 needs to be retrained. In step 340, programmable component 120 adjusts the operating parameters of interface 112 and communicates the adjusted parameters to interface 112. In this way, the performance of memory device 110 can be optimized according to the changes in its operating environment. The process concludes at step 350.

In the embodiment of FIG. 3, the retraining of the interface of the memory device is responding to changes to the input signal, as well as to changes in the operating environment. In an alternative embodiment of the invention, the interface of the memory device may be retrained only in response to changes to the input signal. In another embodiment of the invention, the interface of the memory device may self-tune only in response to one or more changes in the operating environment, as detected through a state monitor.

### CONCLUSION

Performance of a memory device can be affected by changes in an input signal as well as its operating environment. An embedded programmable component on the memory device can analyze such changes and adjust operating parameters at the interface of the memory device accordingly. In this way, the memory device can operate using the adjusted parameters so that such changes will have minimum impact on the performance of the memory device.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed. For example, various aspects of the present invention can be implemented by software, firmware, hardware (or hardware represented by software such, as for example, Verilog or hardware description language instructions), or a combination thereof. Exemplary system 100 in which the present invention, or portions thereof, can be implemented as computer-readable code. After reading this description, it will become apparent to a person skilled in the relevant art how to implement the invention using other computer systems and/or computer architectures.

It should be noted that the simulation, synthesis and/or manufacture of the various embodiments of this invention may be accomplished, in part, through the use of computer readable code, including general programming languages (such as C or C++), hardware description languages (HDL) including Verilog HDL, VHDL, Altera HDL (AHDL) and so on, or other available programming and/or schematic capture tools (such as circuit capture tools). This computer readable code can be disposed in any known computer usable medium including semiconductor, magnetic disk, optical disk (such as CD-ROM, DVD-ROM) and as a computer data signal embodied in a computer usable (e.g., readable) transmission medium (such as a carrier wave or any other medium including digital, optical, or analog-based medium). As such, the code can be transmitted over communication networks including the Internet and internets. It is understood that the functions accomplished and/or structure provided by the systems and techniques described above can be represented in a core (such as a GPU core) that is embodied in program code and may be transformed to hardware as part of the production of integrated circuits.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A memory device comprising:
one or more memory cells; and
an interface in communication with said memory cells and configured to receive an input signal, said interface comprising a programmable component that, when programmed, is configured to train said interface with respect to an operating condition.

2. The memory device of claim 1, wherein said input signal comprises data to be written to said memory cells.

3. The memory device of claim 1, wherein said memory device is a dynamic random access memory (DRAM).

4. The memory device of claim 1, wherein said programmable component comprises a microprocessor.

5. The memory device of claim 1, wherein said programmable component comprises a microcontroller.

6. The memory device of claim 1, wherein said programmable component comprises a micro sequencer.

7. The memory device of claim 1, wherein said programmable component is configured to operate using a reduced instruction set.

8. The memory device of claim 1, wherein said condition comprises receipt, at said interface, of a digital signal wherein when said programmable component is configured to train said interface to detect a data eye in said digital signal.

9. The memory device of claim 8, wherein said digital signal is formatted according to the graphics double data rate 5 (GDDR5) protocol.

10. The memory device of claim 1, further comprising a state monitor in communication with said programmable component wherein said state monitor is configured to detect said condition and inform said programmable component of said condition, and wherein said programmable component is configured to train said interface in response to said condition.

11. The memory device of claim 10, wherein said condition comprises a change in a bandwidth constraint.

12. The memory device of claim 10, wherein said condition comprises a change in a power constraint.

13. The memory device of claim 10, wherein said condition comprises a change in a clock speed constraint.

14. A method of training an interface of a memory device comprising:
(a) executing logic at a programmable component in the interface;
(b) creating an output at the programmable component, the output resulting from said execution;
(c) training the memory device on the basis of the output of the programmable component.

15. The method of claim 14, wherein said input signal is a digital signal, and wherein said step (c) comprises training the interface to find a data eye in the digital signal.

16. The method of claim 15, wherein the input signal is formatted according to the graphics double data rate (GDDR) 5 protocol.

17. The method of claim 14, wherein said step (a) comprises receiving information regarding a change in a power constraint, and said step (c) comprises self-tuning the memory device to modify its power consumption.

18. The method of claim 14, wherein said step (c) comprises receiving information regarding a change in a bandwidth constraint, and said step (c) comprises self-tuning the interface to modify the bandwidth of said input signal.

19. The method of claim 14, wherein the programmable component comprises a microcontroller.

20. The method of claim 19, wherein said logic comprises instructions from a reduced instruction set.

21. A computer program product comprising a computer useable medium having control logic stored therein for training an interface of a memory device, the computer control logic comprising:
first computer readable program code means for causing the execution of logic at a programmable component in the interface;
second computer readable program code means for causing the creation of an output at the programmable component, the output resulting from said execution;
third computer readable program code means for causing the alteration training of the memory device on the basis of the output of the programmable component.

22. The computer program product of claim 21, wherein the computer program code means adapt a processor to:
cause the execution of the logic at the programmable component in the interface;
cause the creation of an output at the programmable component, the output resulting from said execution; and
cause the training of the memory device on the basis of the output of the programmable component.

23. The computer program product of claim 21, wherein the computer program code means comprise HDL instructions.

24. The computer program product of claim 23, wherein the HDL instructions, when processed, are adapted to be used to manufacture a processor capable of:
causing the execution of programmable logic at a programmable component in the interface;
causing the creation of an output at the programmable component, the output resulting from said execution; and
causing the alteration of operation of the memory device on the basis of the output of the programmable component.

25. A computer program product comprising a computer useable medium having control logic stored therein for transmitting instructions to the memory device, wherein execution of the instructions at the memory device causes an interface that is in the memory device and in communication with memory cells, to receive an input signal, and to train said interface with respect to an operating condition.

26. The computer program product of claim 25, wherein the computer program code means adapt a processor to transmit the instructions to the memory device, wherein execution of the instructions at the memory device causes an interface that is in the memory device and in communication with memory cells, to receive an input signal, and to train said interface with respect to an operating condition.

27. The computer program product of claim 25, wherein the computer program code means comprise HDL instructions.

28. The computer program product of claim 27, wherein the HDL instructions, when processed, are adapted to be used to manufacture a processor capable of transmitting the instructions to the memory device.

29. An apparatus configured to transmit instructions to a memory device, wherein execution of the instructions at the memory device causes an interface that is in the memory device and in communication with memory cells, to receive an input signal, and to train said interface with respect to an operating condition.

30. A method of communicating with a memory device, comprising:
transmitting instructions to the memory device, wherein execution of the instructions at the memory device causes an interface that is in the memory device and in communication with memory cells, to receive an input signal, and to train said interface with respect to an operating condition.
